(19) United States
(12) Patent Application Publication
(10) Pub. No.: US 2023/0361371 A1
(43) Pub. Date: Nov. 9, 2023

(54) METHOD FOR RECYCLING A LITHIUM ION BATTERY ELECTRODE, PRECURSOR MIXTURE AND ELECTRODE COMPOSITION FOR SAID BATTERY

(71) Applicant: HUTCHINSON, Paris (FR)

(72) Inventors: Bruno DUFOUR, CHAMPAGNE SUR SEINE (FR); Ksenia ASTAFYEVA, MONTARGIS (FR); Capucine DOUSSET, MONTARGIS (FR)

(21) Appl. No.: 18/028,588

(22) PCT Filed: Sep. 29, 2021
(86) PCT No.: PCT/FR2021/051689

§ 371 Date: Mar. 27, 2023

(30) Foreign Application Priority Data
Sep. 29, 2020 (FR) FR20 09896

(51) Int. Cl. H01M 10/0525; H01M 4/587; H01M 4/1393; H01M 4/62; H01M 4/1391; H01M 4/04; H01M 4/525; H01M 10/54

(52) U.S. Cl. CPC H01M 10/54; H01M 4/0404; H01M 4/0471; H01M 4/1391; H01M 4/1393; H01M 4/525; H01M 4/587; H01M 4/622; H01M 10/0525

(57) ABSTRACT

The invention relates in particular to a method for recycling a first electrode for a lithium-ion battery, a precursor mixture of an electrode composition obtained through this recycling, and the composition resulting therefrom.

The first electrode includes a first collector and a first coating which comprises first ingredients, and the method comprises:
a) separating the first coating from the first collector,
b) melt mixing, without solvent, the recovered first coating with new second ingredients comprising a second active material, a second binder comprising a permanent binder and a sacrificial binder, and an electrically-conductive second additive to obtain the precursor mixture, then
c) eliminating the sacrificial binder to obtain the composition forming a second electrode coating.

### FIELD OF THE INVENTION

The invention relates to a method for recycling a first electrode for a lithium-ion battery, a method for recycling at least one cell of a spent lithium-ion battery, a precursor mixture of an electrode composition for a lithium-ion battery obtained by this electrode recycling, and the electrode composition resulting from this precursor mixture. In particular, the invention applies to a recycling of a starting electrode for a lithium-ion battery and of such a battery allowing obtaining, from this starting electrode, another functional electrode of the same polarity (i.e. anode or cathode) capable of being integrated into a new lithium-ion battery. In particular, the starting electrode may be new and functional (i.e. not yet integrated into a battery and able to operate within this battery), defective (or intended for scrap), or spent (i.e. extracted from a lithium-ion battery at the end of service life).

### BACKGROUND OF THE INVENTION

In a known manner, lithium-ion batteries have a great autonomy of use in electric and hybrid motor vehicles. The popularity of these vehicles has been growing exponentially for years, resulting, with a lag of about five to seven years, in the accumulation of spent lithium-ion batteries, which have been used to power these vehicles.

As described for example in US 7,235,332 B2, the electrodes of lithium-ion batteries are usually manufactured by a coating process comprising steps of dispersing the compounds of the electrode coating in an organic solvent such as N-methyl pyrrolidone (NMP), spreading the obtained dispersion over a metal collector, then evaporating the solvent.

This coating process has many drawbacks from environmental and safety perspectives due to the use of such an organic solvent which, besides its toxicity and its flammability, requires evaporating a large amount thereof. In addition, the dispersion of solid compounds in this solvent according to a very high mass fraction of solid turns out to be delicate, posing problems of sedimentation and coagulation and requiring a dispersion of very good quality. Indeed, the presence of aggregates or impurities can generate coating defects, cracks, bubbles and inhomogeneities in the coated coating.

WO 2015/124835 A2 has suggested preparing a lithium-ion battery electrode coating composition overcoming these drawbacks, by
a) hot melt mixing, without solvent, of an active material, of a polymeric phase forming a binder and a sacrificial polymeric phase to obtain a mixture, the sacrificial phase being according to a mass fraction in the mixture which is equal to or higher than 15%, then by
b) eliminating the sacrificial phase to obtain the composition which comprises the active ingredient according to a mass fraction higher than 80%.

Currently, it is estimated that 2 million tons of lithium-ion batteries worldwide will be used in 2030. The accumulation of these batteries covers materials that are expensive to buy, such as the metals of the current collectors (typically aluminium or copper), rare materials or else very localised resources, such as the active materials of electrodes including alloys of lithiated oxides of transition metals for the cathodes (for example alloys of nickel, manganese and cobalt or of nickel, cobalt and aluminium) and graphite for the anodes. Hence, it is highly desirable to reuse or recycle all or part of these spent batteries, it being specified that a lithium-ion battery for electric vehicles is considered in Europe to be at the end of its service life when its capacity falls down to 80% of its initial capacity.

Different processes are currently known for recycling the different materials present in a spent lithium-ion battery.

WO 2016/174156 A1 discloses a method for treating spent batteries comprising in particular grinding thereof, then an inactivation of the ground material by drying so as to decompose the binders of the electrode coatings and to minimise the amount of electrolyte in the ground and dried material, which is thus almost electrochemically inert for transport thereof. This method further comprises a separation of the active material of the metallic collector supporting it preferably by sieving by airjet, and a purification by hydrometallurgy of the active materials before recycling thereof.

A major drawback of this method lies in the purification of the active materials by hydrometallurgy which is complex, costly and energy-intensive in particular with high CO₂ emissions, and leads to intermediate products which are recycled into electrode coatings by equally costly, energy-intensive steps releasing large amounts of CO₂. In addition, this process does not enable recovering the binder for recycling thereof.

US 9,614,261 B2 discloses a method for recycling an electrode material from spent lithium-ion batteries, comprising:
a collection of a mixed blend of anode and cathode materials,
a separation and a collection of the anode and cathode materials through a separation of three phases in a liquid implemented by centrifugation, then
a purification and a regeneration at high temperature of the anode and cathode materials thus collected, in order to reuse them in lithium-ion batteries.

A major drawback of this method lies in its complexity, and in the fact that it requires the use of toxic and expensive organic solvents in large amounts and includes expensive and energy-intensive pyrolysis steps. In addition, the electrochemical performances of electrodes prepared from active materials thus regenerated are not taught in this document.

WO 2018/169830 A1 discloses a method for recycling an anode material of a lithium-ion battery from one or more charged cell(s) of the battery, which comprises in particular the following steps:
discharge of the battery and/or cooling of the charged cell(s);
opening under a dry atmosphere of the cell(s) charged according to a specific resistive degradation state;
separation of the anode material from the other cell components, the anode material being graphite-based and comprising a PVDF binder and an electrically-conductive additive (acetylene black);
separate cleaning of the anode material using one or more solvent(s) to eliminate this PVDF binder as well as contaminants, at least partially;
mixing of the cleaned anode material with a small amount of the same PVDF binder, to obtain a dispersion in a polar solvent such as NMP, and
deposition then drying of this dispersion over a current collector, to obtain an anode coating.

A major drawback of this last method lies in the limited electrochemical performances of the obtained electrode material, which is limited to an anode material obtained by reusing the purified anode material.

Another drawback of this last method as well as of all those that prescribe recycling of an electrode material in the form of a dispersion in a solvent such as NMP, is that the recycled materials must be free of traces of insoluble or non-dispersible materials present in a spent lithium-ion battery electrode, like for example traces originating from the passivation layers at the anode-electrolyte interface (SEI for short) or from the cathode-electrolyte interface layers (SCI for short), traces of lithium salts or other materials resulting from a degradation of the electrolyte, or originating from the separator.

### DETAILED DESCRIPTION

The present invention aims to provide a method for recycling an electrode for a lithium-ion battery including an electrode coating covering a collector, and for recycling a spent lithium-ion battery incorporating such electrodes, which overcomes in particular the aforementioned drawbacks by enabling a direct and low-cost reuse of anode and cathode coatings already deposited over collectors, without complex or energy-intensive steps, for obtaining a new electrode coating having electrochemical properties (i.e. capacity) and cyclability (i.e. retention of capacity after several cycles) that are both satisfactory.

This aim is achieved in that the Applicant has discovered, surprisingly, that if one hot mixes, through aa molten process and without solvent, a lithium-ion battery electrode coating recovered by separation from its current collector, to new ingredients for an electrode of the same polarity comprising a compatible active material, a permanent binder, a sacrificial binder and an electrically-conductive additive, then it is possible to obtain through this direct recycling of the coating a new electrode coating for lithium-ion battery which, after deposition over a new collector, has electrochemical performances and cyclability comparable to those of a new “control” electrode coating also obtained through a molten process and without solvent which comprises identical mass fractions of the same permanent and sacrificial binders and of the same conductive additive but which is devoid of any recycled coating (replaced by the same new active material).

According to an aspect of the invention, a method for recycling a first electrode for a lithium-ion battery, the first electrode including a first collector and a first coating which covers the first collector and which comprises first ingredients comprising a first active material, a first polymeric binder and a first electrically-conductive additive, comprises:
a) separating the first coating from the first current collector, to recover the first coating,
b) hot melt mixing, without solvent, of all or part of the recovered first coating with new second ingredients usable in a lithium battery second electrode of the same polarity as the first electrode, the second ingredients comprising:
   a second active material compatible with said first active material so that the difference between the respective operating voltages of the first and second active materials is lower than or equal to 1 V in absolute value, according to a mass ratio [first coating / (first coating + second active material)] higher than 0% and lower than or equal to 70%,
   a second binder comprising a permanent polymeric binder and a sacrificial polymeric binder which has a thermal decomposition temperature at least 20° C. lower than that of the permanent polymeric binder, and
   an electrically-conductive second additive, to obtain a precursor mixture of a composition able to form a second coating of the second electrode, then
c) eliminating at least partially the polymeric binder, to obtain said composition.

By “hot melt mixing, without solvent” implemented at step b), it should be understood in a known manner in the present description a mixing of the considered polymers in the molten state in the absence of any solvent, which may be carried out at a temperature which is both
higher than the respective softening temperatures of the first binder and of the second binder (i.e. higher than the softening temperature of the first polymeric binder and the softening temperatures of said permanent polymeric binder and of said sacrificial polymeric binder for the second binder), and
lower than the degradation (i.e. depolymerisation) temperature of said sacrificial polymeric binder.
As a non-limiting example, a temperature comprised between 45° C. and 170° C. may generally be used as the setpoint temperature for this solvent-free mixing.

It should be noted that this melt mixing of the recovered first coating with the second new ingredients allows, through a subsequent elimination of the sacrificial polymeric binder included in these second ingredients, obtaining current density regimes from C/5 to 3C or 5C, maximum discharge capacities substantially of the same magnitude as those obtained for said new “control” electrode coating of the same polarity and with a similar basis weight, and a cyclability also comparable to that of this new “control” coating (which is also obtained through the solvent-free molten process from the same ingredients used according to the same mass fractions while replacing the first coating-second active ingredient mixture with the second active ingredient alone used according to the same mass fraction as this mixture).

As second active material compatible with said first active material, it is possible to select a second active material which is such that the difference between the respective operating voltages of the first and second active materials is preferably lower than or equal to 0.5 V in absolute value. Preferably, the second active material has a chemical composition identical to that of the first active material.

Advantageously, step a) may be implemented by a separation process selected from among:
a mechanical separation preferably implemented
   by abrasion, for example by scraping or sintering, or
   by spraying with subsequent separation of the first current collector, for example by sieving;
a thermal degradation of the first binder with air jet separation as described for example in the article Recycling of lithium-ion batteries: a novel method to separate coating and foil of electrodes, Journal of Cleaner Production, Volume 108, Part A, December 1st, 2015, Pages 301-311, Christian Hanisch, Thomas Loellhoeffel, Jan Diekmann, Kely Jo Markley, Wolfgang Haselrieder, Arno Kwade;
a delamination via pulsations, for example ultrasounds, as known per se in the prior art (cf. for example EP 3 709 433 A1);
a chemical delamination, preferably implemented
   with ethylene glycol at low temperature, as described for example in the article Sustainable Direct Recycling of Lithium-Ion Batteries via Solvent Recovery of Electrode Materials, Dr. Yaocai Bai, Dr. Nitin Muralidharan, Dr. Jianlin Li, Dr. Rachid Essehli, Prof. Dr. Ilias Belharouak published on July 31st, 2020, or
   by chemical treatment of the first binder with a solvent, to reduce the adhesion of the first binder to the first current collector or to dissolve the first binder in the solvent, as described for example in the article Recycling of Electrode Materials from Spent Lithium-Ion Batteries, Xu Zhou, Wen-zhi He, Guang-ming Li, Xiao-jun Zhang, Ju-wen Huang, Shu-guang Zhu, 2010, 4th International Conference on Bioinformatics and Biomedical Engineering (DOI: 10.1109/ICBBE.2010.5518015);
a froth flotation, as described for example in the article A direct recycling case study from a lithium-ion battery recall, Steve Sloop, Lauren Crandon, Marshall Allen, Kara Koetje, Lori Reed, Linda Gaines, Weekit Sirisaksoontorn, Michael Lerner, Sustainable Materials and Technologies, Volume 25, Septembre 2020; and
a combination of at least two of these processes.

It should be noted that this step a) may optionally result in the presence of traces of the current collector in the first coating thus recovered and therefore in the precursor mixture resulting therefrom.

Also advantageously, the recycling method according to the invention may further comprise before step a) a step a0) of providing the first electrode to be recycled, the method possibly having, between steps a0) and b), no step of purification, enrichment, regeneration or pyrolysis of said first coating, the first polymeric binder being kept in the first coating to implement step b).

It should be noted that this absence of a step of purification, enrichment, regeneration or pyrolysis of the first coating in the recycling method according to the invention, which is reflected in particular by the non-elimination of the first binder before recycling, differs from the prior art disclosed in the aforementioned documents.

According to a first embodiment of the invention, the recycling method further comprises, before step a), a step a0) of providing the first electrode to be recycled which is new so that it is not derived from a battery cell, the method having no step of washing the first coating after step a0) and before mixing thereof at step b) with the second ingredients.

It should be noted that this first embodiment relates in particular to a first starting electrode, which may be an anode or a cathode:
new and functional (i.e. still not coupled to an electrolyte or a separator within a battery cell, and able to operate in a lithium-ion battery), or
new, but defective or intended for scrap (i.e. still not coupled to an electrolyte or to a separator within a battery cell, and originating from scrap or residue from the production of electrodes, for example due to a coating defect, cracks, bubbles and/or incorrect porosity of the polymeric coating covering the current collector).

According to a second embodiment of the invention, the recycling method further comprises, before step a), a step a0) of providing the first electrode to be recycled which is derived from a spent lithium-ion battery cell, the method further comprising, between steps a0) and a) or between steps a) and b), a step a1) of washing the first coating to extract therefrom almost all of an electrolyte that the spent lithium-ion battery contained in contact with the first electrode, by means of an organic washing solvent which is generally inert with respect to the first polymeric binder and which comprises, for example, dimethyl carbonate.

It should be noted that this second embodiment relates in particular to a substantially spent first starting electrode which may be an anode or a cathode which may still be functional or not (i.e. extracted from a lithium-ion battery which has already completed at least one charge-discharge cycle and which may be at the end of its service life, i.e. not functional because its electrochemical capacity expressed in mAh/g of electrode reaches only 80% of its initial capacity).

In accordance with said second embodiment, the first coating may further comprise traces of said electrolyte with which the first electrode has been in contact in the spent lithium-ion battery cell, which is an aprotic electrolyte based on Li⁺ cations, for example a solution of lithium hexafluorophosphate (LiPF₆) in an organic solvent such as one or more alkyl carbonate(s) (for example a mixture of ethyl carbonate and dimethyl carbonate as an electrolyte solvent).

It should be noted that the first coating recovered at step a) according to this second embodiment may further comprise all or part of the other insoluble or non-dispersible impurities present in a spent lithium-ion battery electrode, such as traces from passivation layers at the anode-electrolyte interface (SEI) or cathode-electrolyte interface layers (SCI), or traces originating from the separator contained in the cell of the spent lithium-ion battery, given that the melt mixing step b) tolerates the presence of such impurities, unlike wet preparation of electrode coatings typical of the prior art by dispersion in a solvent.

Preferably, the mixing of step b) is carried out according to a mass ratio [first coating / (first coating + second active material)] equal to or higher than 1% and lower than or equal to 65%, which is more preferably inclusively comprised between 5% and 60% and for example between 20% and 55%.

Also preferably and possibly in combination with the ratio hereinabove, the mixing of step b) is carried out according to a mass fraction of all of the first coating and of the second active material in the entirety of said precursor mixture which is inclusively comprised between 55% and 85%, preferably between 60% and 80%.

Also preferably and possibly in combination with all or part of the foregoing, the mixing of step b) is carried out with the sacrificial polymeric binder which is selected from among polyalkene carbonates, step c) being preferably implemented by thermal decomposition, for example in a vat under air or a furnace, under nitrogen.

Still more preferably, the sacrificial polymeric binder, thermally decomposed at step c), comprises at least one poly(alkene carbonate) polyol including end groups more than 50 mol% (and possibly more than 80 mol%) of which comprise hydroxyl functions, the sacrificial polymeric binder possibly comprising:
a said poly(alkene carbonate) polyol with a weight-average molecular mass comprised between 500 g/mol and 5,000 g/mol, for example according to a mass fraction in the sacrificial polymeric binder higher than 50% (for example comprised between 55% and 75%), and
a poly(alkene carbonate) with a weight-average molecular mass comprised between 20,000 g/mol and 400,000 g/mol, for example according to a mass fraction in the sacrificial polymeric binder lower than 50% (for example comprised between 25% and 45%).

Advantageously, said at least one poly(alkene carbonate) polyol may be a linear aliphatic diol selected from among poly(ethylene carbonate) diols and poly(propylene carbonate) diols with a weight-average molecular mass Mw comprised between 500 g/mol and 5,000 g/mol, preferably between 700 g/mol and 2,000 g/mol. As example, one could, more advantageously, use a poly(propylene carbonate) diol of the following formula:

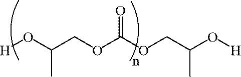

According to a variant of the invention, step c) may be implemented by any other process enabling the total or partial extraction of the sacrificial polymeric binder without impacting the rest of the mixture, for example through an extraction by a solvent with as sacrificial binder thus extractable by the liquid process at least one polymer, for example selected from among the group consisting of polyethylene glycols, polypropylene glycols and mixtures thereof.

In general, it should be noted that the elimination of the sacrificial binder at step c) of the method according to the invention is preferably total or almost total, i.e. substantially with no decomposition or extraction residue.

According to another aspect of the invention, the mixing of step b) is carried out with the permanent polymeric binder which may be different from the first polymeric binder, for example with:
the first polymeric binder comprises a halogenated thermoplastic polymer, such as a polyvinylidene difluoride (PVDF), and
the permanent polymeric binder which comprises a non-halogenated thermoplastic polymer or an elastomer selected from among thermoplastic elastomers and rubbers, for example a rubber which may be diene (crosslinked or non-crosslinked), such as a styrene-butadiene copolymer (SBR), an acrylonitrile-butadiene copolymer (NBR) or a hydrogenated acrylonitrile-butadiene copolymer (HNBR).

As non-halogenated thermoplastic polymer for the permanent binder, it is possible to use an apolar aliphatic polyolefin of the homopolymer or copolymer type (including by definition terpolymers), derived from at least one alkene and optionally in addition to a comonomer other than an alkene, for example selected from among polyethylenes (for example HDPE or LDPE), polypropylenes (PP), polybutenes-1 and polymethylpentenes. Alternatively, this non-halogenated thermoplastic polymer may be a copolymer of ethylene and an acrylate, such as an ethylene-ethyl acrylate polymer, an ethylene-octene, ethylene-butene, propylene-butene or ethylene-butene -hexene copolymer.

As a non-diene rubber for the permanent binder, mention may be made of polyisobutylenes, copolymers of ethylene and of an alpha-olefin such as ethylene-propylene copolymers (EPM) and ethylene-propylene-diene terpolymers (EPDM).

It should be noted that each of the precursor mixture obtained at step b) and the second coating obtained at step c) may in this case comprise, as permanent binders, two polymers belonging to very different families, i.e. a halogenated thermoplastic polymer, on the one hand, and a non-halogenated thermoplastic polymer or an elastomer of the thermoplastic elastomer or rubber type, for example diene, on the other hand, unlike common practice.

According to another aspect of the invention, each of the first electrode and the second electrode is:
an anode, with the first active material and the second active material which are preferably identical or similar and each comprises for example the same graphite, or
a cathode, with the first active material and the second active material which are preferably identical or similar and each comprises for example the same alloy of lithiated oxides of transition metals preferably selected from among the group consisting of alloys of lithiated oxides of nickel, manganese and cobalt (NMC) and alloys of lithiated oxides of nickel, cobalt and aluminium (NCA).

As explained hereinabove, it should be noted that the second active material is selected so as to be compatible with the first active material preferably by means of the aforementioned criterion of absolute value of the difference of the respective operating voltages of these two active materials lower than or equal to 1 V, and still more preferably also by the fact that the two active materials belong to the same chemical family (for example graphite for an anode, an alloy comprising at least the same metals for the cathode second active material).

As first and second active material(s), it is also possible to use other active inorganic fillers capable of enabling insertion/deinsertion of lithium for the lithium-ion battery electrodes, comprising lithiated polyanionic compounds or complexes such as a phosphate of a lithiated metal M of formula LiMPO₄ coated with carbon (for example C-LiFePO₄), a lithiated titanium oxide of formula Li₄Ti₅O₁₂, or any other active material known to a person skilled in the art for cathodes (for example LiCoO₂, LiMnO₄) or anodes.

As electrically-conductive additive(s), it is possible to use, for example, a conductive carbon black, for example a high-purity one, an expanded graphite, graphene, carbon nanofibers, carbon nanotubes or a mixture of at least two of these.

According to another feature of the invention, the method may comprise between steps b) and c) the following steps:
b1) shaping the precursor mixture obtained in b) in the form of a sheet, for example by calendering, and
b2) depositing the sheet of the precursor mixture obtained in b1) over a second current collector, in order to obtain the second electrode by implementing step c).

A method according to the invention for recycling at least one cell of a spent lithium-ion battery including a packaging or an envelope, comprising the following steps:
(i) a dismemberment of said at least one cell to remove said case and recover a first anode comprising a first anode collector covered with a first anode coating impregnated with an electrolyte, a first cathode comprising a first cathode covered with a first cathode coating impregnated with the electrolyte, and a separator, and
(ii) recycling according to the invention disclosed hereinabove of the first anode and/or of the first cathode, each forming said spent first electrode to be recycled.

It should be noted that step (i) consists in disassembling all or part of the spent battery, for example at the end of its service life (i.e. when its capacity is reduced to 80% at most of its initial capacity) to remove its packaging and recover the electrodes (collectors and affixed electrode coatings included) impregnated in electrolyte and the separators, and that step (ii) of recycling at least one of the two electrodes of the or each cell consists in implementing the aforementioned steps a), b) and c) of the recycling method presented hereinabove in the particular case where the or each electrode to be recycled originates from a spent lithium-ion battery which involves implementing the aforementioned step a1).

A precursor mixture according to the invention of an electrode coating composition for a lithium-ion battery, the composition being obtained by a method according to the invention for recycling a first electrode as defined hereinabove, wherein the precursor mixture comprises the product of a hot reaction, through a molten process and without solvent, of:
all or part of a first coating which comprises first ingredients comprising a first active material, a first polymeric binder and a first electrically-conductive additive, the first coating being recovered from the first electrode through a separation from a first current collector implemented by a method selected from among :
   a mechanical separation preferably
   by abrasion, for example implemented by scraping or sintering, or
   by spraying with subsequent separation of the first current collector, for example by sieving;
   a thermal degradation of the first binder with air jet separation;
   a delamination via pulsations, for example ultrasounds;
   a chemical delamination, preferably
   with ethylene glycol at low temperature, or
   by chemical treatment of the first binder with a solvent, to reduce the adhesion of the first binder to the first current collector or to dissolve the first binder in the solvent; a froth flotation; and
   a combination of at least two of these processes, with
new second ingredients usable in a lithium-ion battery second electrode of the same polarity as the first electrode, the second ingredients comprising a second active material compatible with the first active material so that the difference between the respective operating voltages of said first active material and of said second active material is lower than or equal to 1 V in absolute value, a second binder comprising a permanent polymeric binder and a sacrificial polymeric binder which has a thermal decomposition temperature at least 20° C. lower than that of the permanent polymeric binder, and an electrically-conductive second additive.

It should be noted that this precursor mixture is not only characterised by the fact that it comprises a sacrificial polymeric binder and is devoid of solvent, but also that it is directly derived from scraping of the first coating of the first current collector.

According to another aspect of the invention, this precursor mixture may be such that the sacrificial polymeric binder is selected from among polyalkene carbonates, the polymeric binder comprising, for example, at least one poly(alkene carbonate) polyol including end groups more than 50 mol% of which comprise hydroxyl functions.

Advantageously, this precursor mixture may also be such that:
the permanent polymeric binder comprises a non-halogenated thermoplastic polymer or an elastomer selected from among thermoplastic elastomers and rubbers, for example a diene rubber (crosslinked or non-crosslinked), such as a styrene-butadiene copolymer (SBR), an acrylonitrile-butadiene copolymer (NBR) or a hydrogenated acrylonitrile-butadiene copolymer (HNBR), and that
the first polymeric binder of the recovered first coating comprises a halogenated thermoplastic polymer, such as a polyvinylidene difluoride (PVDF).

As explained hereinabove, it should be noted that this combination of permanent binders with very different chemical structures, i.e. a halogenated thermoplastic polymer, on the one hand, and a non-halogenated thermoplastic polymer or an elastomer selected from among thermoplastic elastomers and rubbers, for example a diene rubber, on the other hand, differs from the prior art consisting in particular of the aforementioned documents (cf. for example WO 2018/169830 A1 which teaches the use of one same PVDF binder for the new electrode coating).

According to another feature of the invention which may depend, or not, on the aforementioned chemical structures of said first binder and of said permanent binder, this precursor mixture may be such that the first electrode is derived from a spent lithium-ion battery, the first coating which is derived therefrom then further comprising traces of an electrolyte that the spent lithium-ion battery contained in contact with the first electrode and which is an aprotic electrolyte based on Li⁺ cations, for example a solution of lithium hexafluorophosphate (LiPF₆) in an organic solvent such as one or more alkyl carbonate(s).

An electrode composition according to the invention for a lithium-ion battery comprises the product of a total or partial thermal decomposition reaction of a precursor mixture according to the invention as defined hereinabove, and preferably said composition comprises:
said permanent polymeric binder, which comprises a non-halogenated thermoplastic polymer or an elastomer selected from among thermoplastic elastomers and rubbers, for example a crosslinked or non-crosslinked rubber which may be diene, such as a styrene-butadiene copolymer (SBR), an acrylonitrile-butadiene copolymer (NBR) or a hydrogenated acrylonitrile-butadiene copolymer (HNBR),
said first polymeric binder of the recovered first coating, which comprises a halogenated thermoplastic polymer, such as a polyvinylidene difluoride (PVDF), and
optionally in the case where said first electrode is derived from a spent lithium-ion battery, traces of an aprotic electrolyte based on Li⁺ cations that the spent lithium-ion battery contained in contact with the first electrode, said traces comprising for example fluorine atoms.

It should be noted that this electrode composition finally obtained which forms the new electrode coating according to the invention obtained by the aforementioned recycling could be characterised not only by the aforementioned combination of several permanent binders with very different chemical structures, but also by the fact that it could comprise impurities originating from a spent lithium-ion battery, such as these electrolyte traces of or other elements of the battery.

It should also be noted that an electrode composition according to the invention may also comprise a plurality of different yet compatible active materials, as explained hereinabove.

### BRIEF DESCRIPTION OF THE DRAWINGS

Other features, advantages and details of the present invention will appear upon reading the following description of several embodiments of the invention, provided for illustrative and non-limiting purposes with reference to the appended drawings, among which:

FIG. 1 is a scanning electron microscope (SEM) image coupled with energy dispersive spectrometry (EDX) of a first anode coating which originates from a spent lithium-ion battery and which has been recycled in Example 1 according to the invention.

FIG. 2 is a graph showing the elemental composition obtained by thermogravimetric analysis (TGA) of the first anode coating of FIG. 1.

FIG. 3 is a graph showing the mass content of the first binder in the first anode coating of FIGS. 1 and 2, also obtained by ATG.

FIG. 4 is a graph comparing the cyclability (capacity in mAh/g of electrode as a function of the number of charge-discharge cycles in C/5) of a preferred cathode according to the invention obtained by recycling in Example 2 according to the invention of a first cathode coating, of another cathode according to the invention obtained by recycling the same first cathode coating according to another mass fraction, and of a “control” cathode obtained without recycling from the same new ingredients as those added to the first coating.

FIG. 5 is a graph comparing the cyclability (capacity in mAh/g of an electrode as a function of the number of charge-discharge cycles at C/5) of two other cathodes not in accordance with the invention obtained by recycling said first cathode coating according to two other mass fractions.

### EXEMPLARY EMBODIMENTS OF THE INVENTION

Electrode coating compositions according to the invention, “control” ones not in accordance with the invention, have been prepared by implementing the following protocol of melt mixing, shaping, deposition over a collector then elimination of the sacrificial binder, starting from recycled first electrode coatings in order to obtain second coating compositions according to the invention and not in accordance with the invention, and starting from new ingredients in order to obtain “control” electrode coating compositions.

To obtain each of these electrode compositions, each precursor mixture has been processed by a molten process and without solvent in a “Haake Polylab OS” type internal mixer, with a capacity of 69 cm3 and at a temperature comprised between 60° C. and 75° C.

Then, the precursor mixtures thus obtained have been shaped by calendering at room temperature (22° C.) using a “Scamex” external cylinder mixer until reaching an electrode coating thickness of 600 µm. Afterwards, these precursor mixtures have been calendered again at 70° C. in order to reach a thickness of 50 µm to 150 µm.

Then the precursor mixtures thus calendered have been deposited over a metal current collector using a sheet calender at 70° C. The used collector has been made of aluminium coated with carbon for the cathodes based on an active material made of an NMC alloy, and of copper for the anodes based on graphite.

Afterwards, each precursor mixture previously deposited over the corresponding current collector has been placed in a ventilated vat or a furnace, in order to extract the sacrificial polymeric binder therefrom, by subjecting each precursor mixture to a heat treatment in a vat under ambient air in a first test, or under an inert atmosphere in a second test (in a rotary furnace under nitrogen, with a nitrogen flow rate of 1 L/min).

In both cases, this heat treatment consisted of a temperature ramp from 50° C. to 250° C. then of an isotherm for 30 min at 250° C. for the evaporation of the sacrificial binder.

### Protocol for Measuring Electrochemical Performances in Button Cells

The electrodes thus prepared have been cut out with a die cutter (diameter 16 mm, surface area 2.01 cm²), then weighed. The mass of active material has been determined by subtracting the mass of the bare current collector prepared according to the same conditions (heat treatments). The electrodes thus cut have been placed in a furnace directly connected to a glove box, then they have been dried at 100° C. under vacuum for 12 hours before transferring them to the glove box (under an argon atmosphere at 0. 1 ppm H₂O and 0.1 ppm O₂).

Afterwards, for each prepared electrode forming an anode or cathode to be tested, a button cell (CR1620 format) has been assembled using a metallic lithium counter-electrode, a “Cellgard 2500” separator and a LiPF6 EC/ DMC (50/50% by mass) battery grade electrolyte.

The batteries thus obtained have been characterised on a “Biologic VMP3” potentiostat. To this end, charge/discharge cycles at constant current between 1 V and 10 mV for the anodes and between 4.0 V and 2.5 V for the cathodes have been carried out.

As regards the anodes (based on graphite), the galvanostatic measurements of electrochemical capacity have been carried out at current densities of C/5, C/2, C, 2C and 5C, while considering the mass of active material and a theoretical capacity of 372 mAh/g. As regards the cathodes (based on an NMC alloy), the galvanostatic measurements have been carried out at current densities of C/5, C/2, C, 2C and 3C, while considering the mass of active material and a theoretical capacity of 200 mAh/g.

In order to compare the performances of the different systems, the capacities upon the fifth discharge (disinsertion of lithium) for the anodes and the charge for the cathodes have been assessed, at each current density. Then, the button cells have been cycled at the constant current density of C/5 for the anodes and C/2 for the cathodes, in order to quantify the cyclability of the tested electrodes. The potential terminals for each electrode have been kept.

### Example 1 of Preparation of Two Anodes According to the Invention 11, 11′ From Scrap Commercial Lithium-Ion Batteries, and a “Control” Anode C1 Only From New Ingredients:

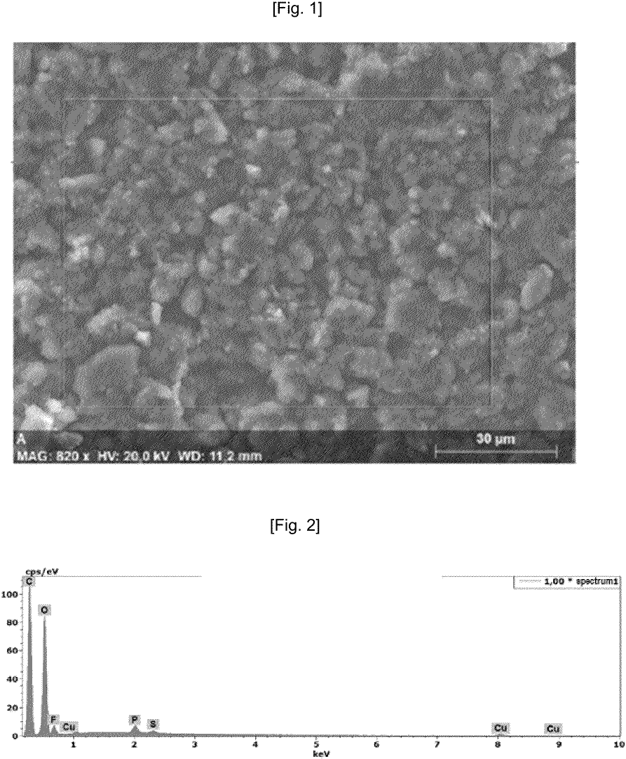

Two precursor mixtures of anodes according to the invention have been prepared, respectively intended to form two compositions according to the invention 11, 11′ of second anode coatings, by implementing the following steps:
a0) Dismantling two spent lithium-ion batteries of Dell® brand laptops and model 38 Wh type RYXXH, 11.1 V (batteries “Dell® 1” for composition 11 and “Dell® 2” for composition 11′, batteries with capacities reduced to less than 80% of their initial capacities), by removing the packaging and recovering the current collectors coated with spent first electrode coatings, which were impregnated with the electrolyte of the battery and were in contact with the separator;
a1) Washing each first anode coating in an organic solvent consisting of dimethyl carbonate (DMC), to extract the electrolyte therefrom;
   a) Mechanical separation by abrasion of each first anode coating thus washed from the current collector made of copper, by scraping;
   b) melt mixing according to the protocol hereinabove of each first coating thus washed and recovered (which comprises insoluble impurities originating from the electrolyte and potentially from other components of the battery, as explained hereinbelow with reference to FIGS. 1 and 2) with new second anode ingredients for a lithium-ion battery comprising:
      a second active material (graphite) similar to that of the first coating,
      a polymeric binder comprising a permanent binder (PVDF SBR mixture) and a sacrificial binder (liquid PPC polyol solid PPC mixture), and
      an electrically-conductive additive (carbon black), to obtain a precursor mixture of each composition 11, 11′ of the anode second coating; and
   c) eliminating the sacrificial binder by thermal decomposition by the aforementioned heat treatment, for example in the ventilated vat under ambient air, after calendering then depositing the precursor mixture over another copper collector, to obtain each composition 11, 11′.

As regards the “control” anode, it has been obtained by depositing over the same collector made of copper a “control” anode coating C1 derived from a “control” precursor mixture consisting of the same anode new second ingredients and their respective amounts as for the precursor mixtures of the compositions 11 and 11′, except that this “control” precursor mixture was devoid of the recycled first coating with instead and in the same amount the same active material consisting of graphite.

FIG. 1 illustrates the morphology obtained by the SEM-MEX technique of the recycled first anode coating after the washing step a1), to obtain the precursor mixture of the composition 11. Excess solvent has been removed by simple solvent soaking (DMC) for two minutes.

FIG. 2, which shows the elementary composition obtained by ATG of this recycled first anode coating, confirms that it is based on graphite as active material, the elements O, P, S and F being derived from electrolyte traces at the surface of the recycled anode and which may also originate from the binder of this first coating, it being specified that the element Cu came from the SEM measurement support.

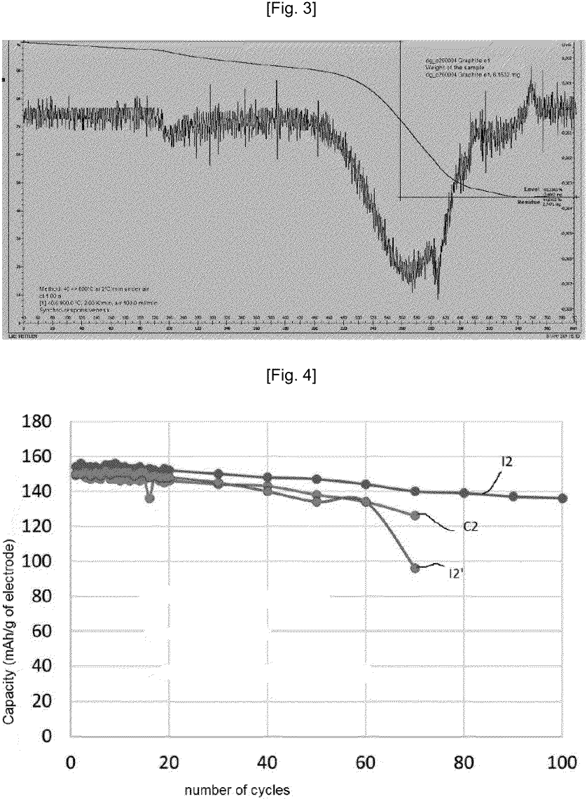

FIG. 3 shows that the rate of the PVDF-SBR binder in this first recycled anode coating was about 4% (cf. the first peak at 240° C.).

Table 1 hereinafter details the ingredients and the formulation of the precursor mixture of each composition I1, I1′ according to the invention.

TABLE 1

| Ingredients of the precursor mixture of the compositions I1, I1′ | Amounts (g) |
|---|---|
| Mixture of 25% of the recycled first coating based on graphite + 75% of the active second material: natural graphite (Targray)* | 42.19 |
| Electrically-conductive second additive: Super C65 (Timcal) carbon black | 1.35 |
| Permanent second binder: SBR Buna 1502 (Arlanxeo Performance Elastomers) | 1.35 |
| Liquid sacrificial binder: Converge® Polyol 212-10 (Novomer) polypropylene carbonate | 13.76 |
| Solid sacrificial binder: QPAC® 40 (Empower Materials) polypropylene carbonate | 7.41 |

* mass ratio [1st coating / (1st coating + 2nd active ingredient)] = 25%

Table 2 hereinafter details the ingredients and the formulation of the precursor mixture of the “control” composition C1 according to the invention.

TABLE 2

| Ingredients of the precursor mixture of the composition C1 | Amounts (g) |
|---|---|
| new natural graphite (Targray) | 42.19 |
| New electrically-conductive additive: Super C65 (Timcal) carbon black | 1.35 |
| Permanent binder: SBR Buna 1502 (Arlanxeo Performance Elastomers) | 1.35 |
| Liquid sacrificial binder: Converge® Polyol 212-10 (Novomer) polypropylene carbonate | 13.76 |
| Solid sacrificial binder: QPAC® 40 (Empower Materials) polypropylene carbonate | 7.41 |

### Results of the Electrochemical Measurements on the Anodes

Table 3 hereinafter gives an account of the capacitive performances obtained at the C/5 to 5C regimes for the anodes incorporating the compositions I1, I1′ according to the invention and the “control” composition C1, respectively.

TABLE 3

| Anode compositions | Basis weight mg/cm² | C/5 | C/2 | C | 2C | 5C |
|---|---|---|---|---|---|---|
| | | mAh/g of anode | | | | |
| I1 | 6.76 | 325 | 326 | 327 | 323 | 203 |
| I1′ | 6.85 | 327 | 330 | 325 | 322 | 144 |
| C1 | 6.90 | 329 | 323 | 325 | 334 | 185 |

These results show that, surprisingly, the electrochemical performances of the anodes I1 and I1′ according to the invention derived from spent anodes of different disassembled lithium-ion batteries (respectively “Dell 1” and “Dell 2”) via the recycling of the corresponding anode coatings, are of the same magnitude at regimes from C/5 to 5C as the performances of the “control” anode C1 obtained with the same amounts of the corresponding new ingredients (including the same graphitic active material, instead of mixing thereof with the first coating). In addition, the performance of the anodes according to the invention I1, I1′ was sometimes higher to that of the “control” anode C1, as shown by the capacities measured at C/2 and C.

### Example 2 of Preparation of Two Cathodes According to the Invention I2, I2′, of Two cAthodes Not in Accordance With the Invention C2′, C2″ From New Cathodes Not Integrated Into a Lithium-Ion Battery, and of a “Control” Cathode C2 Only From New Ingredients:

Cathode precursor mixtures respectively intended to form two compositions according to the invention I2, I2′ and two compositions not in accordance with the invention C2′, C2″ have been prepared by implementing the following steps:
a) starting from new first cathodes (never assembled in lithium-ion cells or electrochemically tested) of the CustomCells® brand and denomination “NCM-622” (plates commercialised by CustomCells GmbH of 2.0 mAh/cm², 10 × 10 cm, manufacturer reference 373662040), formed by a first coating which covered over only one face an aluminium collector and comprised as active material an NMC alloy of lithiated oxides of nickel, manganese and cobalt, a PVDF binder and an electrically-conductive additive, implementation of a mechanical separation by scraping the first coating from the collector;
b) melt mixing according to the protocol hereinabove of each recovered first coating with new second ingredients comprising:
   a second active material similar to that of the first coating (NMC 622),
   a polymeric binder comprising a permanent binder (HNBR) and a sacrificial binder (liquid PPC polyol solid PPC mixture), and
   an electrically-conductive additive (carbon black), to obtain precursor mixtures of the compositions I2, I2′, C2′, C2″ with various mass ratios [1st coating / (1st coating + 2nd active material)]; and
c) eliminating the sacrificial binder by thermal decomposition by the aforementioned heat treatment, for example in the ventilated vat under ambient air, after calendering then depositing the precursor mixture over another collector made of aluminium, to obtain each composition I2, I2′, C2′, C2″ of second cathode coating.

As regards the “control” cathode C2, it has been obtained by depositing over the same aluminium collector a “control” cathode coating derived from a “control” precursor mixture, consisting of the same cathode new second ingredients and their respective amounts as for the precursor mixtures of the compositions I2, I2′, C2′, C2″, except that this “control” precursor mixture of C2 was devoid of the recycled first coating with instead and according to the same amount the same active ingredient consisting of NMC 622.

The compositions I2, I2′, C2, C2′, C2″ have further been calendered again to obtain coatings having a volumetric porosity of 38%. Tables 4-8 hereinafter detail the precursor mixtures used for these compositions.

Table 4 details the ingredients and the formulation of the precursor mixture of the preferred cathode composition I2 according to the invention.

TABLE 4

| Ingredients of the precursor mixture of the composition I2 | Amounts (g) |
|---|---|
| Mixture of 25% of the recycled 1st coating “NCM 622” + 75% of the active 2nd material NMC 622 (Targray)* | 86.09 |
| Electrically-conductive second additive: Super C65 (Timcal) carbon black | 6.70 |
| Permanent second binder: HNBR Zetpol 0020 (Zeon Chemicals LP) 50% of acrylonitrile units | 2.87 |
| Liquid sacrificial binder: Converge® Polyol 212-10 (Novomer) polypropylene carbonate | 12.45 |
| Solid sacrificial binder: QPAC® 40 (Empower Materials) polypropylene carbonate | 6.70 |

* mass ratio [1st coating / (1st coating + 2nd active ingredient)] = 25%

Table 5 details the ingredients and the formulation of the precursor mixture of the “control” composition C2 according to the invention.

TABLE 5

| Ingredients of the precursor mixture of the composition C2 | Amounts (g) |
|---|---|
| active material NMC 622 (Targray) | 86.09 |
| New electrically-conductive additive: Super C65 (Timcal) carbon black | 6.70 |
| Permanent binder: SBR Buna 1502 (Arlanxeo Performance Elastomers) | 2.87 |
| Liquid sacrificial binder: Converge® Polyol 212-10 (Novomer) polypropylene carbonate | 12.45 |
| Solid sacrificial binder: QPAC® 40 (Empower Materials) polypropylene carbonate | 6.70 |

Table 6 details the ingredients and the formulation of the precursor mixture of the other composition I2′ according to the invention.

TABLE 6

| Ingredients of the precursor mixture of the composition I2 | Amounts (g) |
|---|---|
| Cathode recycled 1st coating “NCM 622”* | 47.83 |
| 2nd active material NMC 622(Targray)* | 43.05 |
| Electrically-conductive second additive: Super C65 (Timcal) carbon black | 3.35 |
| Permanent second binder: HNBR Zetpol 0020 (Zeon Chemicals LP) 50% of acrylonitrile units | 1.44 |
| Liquid sacrificial binder: Converge® Polyol 212-10 (Novomer) polypropylene carbonate | 12.45 |
| Solid sacrificial binder: QPAC® 40 (Empower Materials) polypropylene carbonate | 6.70 |

* mass ratio [1st coating / (1st coating + 2nd active ingredient)] = 52.6 %

Table 7 details the ingredients and the formulation of the precursor mixture of the composition C2′ not in accordance with the invention.

TABLE 7

| Ingredients of the precursor mixture of the composition C2′ | Amounts (g) |
|---|---|
| Cathode recycled 1st coating “NCM 622”* | 2.000 |
| 2nd active material NMC 622(Targray)* | 0.464 |
| Electrically-conductive second additive: Super C65 (Timcal) carbon black | 0.036 |
| Permanent second binder: HNBR Zetpol 0020 (Zeon Chemicals LP) 50% of acrylonitrile units | 0.015 |
| Liquid sacrificial binder: Converge® Polyol 212-10 (Novomer) polypropylene carbonate | 0.224 |
| Solid sacrificial binder: QPAC® 40 (Empower Materials) polypropylene carbonate | 0.121 |

* mass ratio [1st coating / (1st coating + 2nd active ingredient)] = 81.2 %

Table 8 hereinafter details the ingredients and the formulation of the precursor mixture of the other composition C2″ not in accordance with the invention.

TABLE 8

| Ingredients of the precursor mixture of the composition C2″ | Amounts (g) |
|---|---|
| Cathode recycled 1st coating “NCM 622″* | 2.0000 |
| 2nd active material NMC 622(Targray)* | 0.1346 |
| Electrically-conductive second additive: Super C65 (Timcal) | 0.0105 |
| Permanent second binder: HNBR Zetpol 0020 (Zeon Chemicals LP) 50% of acrylonitrile units | 0.0045 |
| Liquid sacrificial binder: Converge® Polyol 212-10 (Novomer) polypropylene carbonate | 0.1303 |
| Solid sacrificial binder: QPAC® 40 (Empower Materials) polypropylene carbonate | 0.0701 |

* mass ratio [1st coating / (1st coating + 2nd active ingredient)] = 93.7 %

Thus, the cathode coatings I2, I2′, C2, C2′, C2″ have been successfully shaped, which had a surface area of about 25 cm² and a basis weight substantially comprised between 21 and 25 mg/cm². These cathodes have remained cohesive after elimination of the sacrificial binder at 250° C., and have withstood die cutting satisfactorily.

### Results of the Electrochemical Measurements on the Cathodes

Table 9 hereinafter gives an account of the capacitive performances obtained at the regimes C/5 to 3C for the cathodes incorporating the compositions I2, I2′, C2, C2′, C2″.

TABLE 9

| Anode compositions | Basis weight mg/cm² | C/5 | C/2 | C | 2C | 3C |
|---|---|---|---|---|---|---|
| | | mAh/g of anode | | | | |
| I2 | 24.6 | 166 | 161 | 152 | 140 | 126 |
| I2′ | 23.6 | 159 | 152 | 138 | 64 | 14 |
| C2 | 21.4 | 157 | 160 | 142 | 119 | 39 |
| C2′ | 25.2 | 151 | 141 | 126 | 46 | 8 |
| C2″ | 24.2 | 111 | 63 | 23 | 0 | 0 |

These results show that, surprisingly, the electrochemical performances of the cathodes I2 and I2′ according to the invention derived from new commercial cathodes through recycling of the corresponding cathode coatings, are of the same magnitude at regimes from C/5 to C (and possibly to 2C for the cathode I2) as the performances of the “control” cathode C2 obtained with the same amounts of the corresponding new ingredients (including the same NMC type active material instead of mixing the latter with the first coating).

More specifically, the performance of the cathode I2 of the invention with a mass ratio [1st coating / (1st coating + 2nd active material)] of 25%, a preferred embodiment of the invention, has always been higher than that of the “control” cathode » C2, as shown by the capacities measured at regimes from C/5 to 3C (cf. the capacity of the cathode I2 increased by more than 220% at this high regime of 3C compared to the cathode C2).

As regards the cathode I2′ of the invention, these results show that the recycling of the first cathode coating (according to a mass ratio of about 50% with respect to the 1st coating-2nd active material set) allows substantially preserving the capacity values at regimes from C/5 to C, even though it penalises them at higher regimes of 2C and 3C.

As shown in the graph of FIG. 4, the preferred cathode I2 according to the invention had a cyclability always higher than that of the “control” cathode C2 at the charge-discharge regime C/5, even after 100 cycles at C/5, while the other cathode I2′ according to the invention featured a drop in capacity after 60-70 cycles compared to the “control” cathode C2.

As regards the cathodes C2′ and C2″ not in accordance with the invention, Table 9 hereinabove shows that the integration of about 80% and more by mass of recycled first coating in the 1st coating-2nd active material set degrades the electrochemical performance, especially at current densities higher than 1C (cf. the non-acceptable capacities obtained at the regimes 2C and 3C).

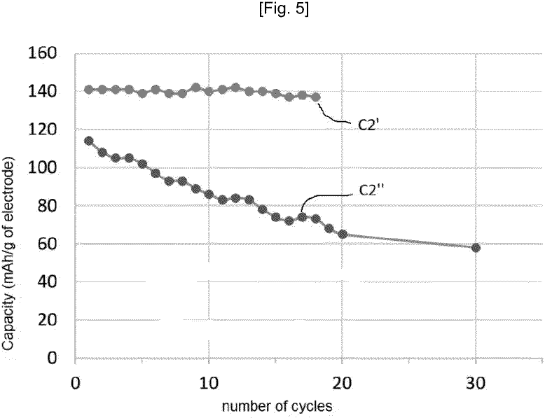

And as shown in the graph of FIG. 5, the cathode C2″ with more than 90% by mass of recycled first coating in the first coating-second active material set features a rapid degradation of capacity at the C/5 regime after 10-20 cycles.

However, it should be noted that the selection of a mass fraction of the second permanent binder higher than that used in the aforementioned examples and/or a different particle size distribution of the agglomerates resulting from the recycled first coating could allow improving the cohesion of these agglomerates even more and thus improving the capacities of the obtained electrodes.

1. A method for recycling a first electrode for a lithium-ion battery, the first electrode including a first current collector and a first coating which covers the first collector and which comprises first ingredients comprising a first active material, a first polymeric binder and a first electrically-conductive additive,
wherein the method comprises:
a) separating the first coating from the first current collector, to recover the first coating,
b) hot melt mixing, without solvent, of all or part of the recovered first coating with new second ingredients usable in a lithium battery second electrode of the same polarity as the first electrode, the second ingredients comprising:
a second active material compatible with said first active material so that the difference between the respective operating voltages of said first active material and of said second active material is lower than or equal to 1 V in absolute value, according to a mass ratio [first coating / (first coating + second active material)] higher than 0% and lower than or equal to 70%,
a second binder comprising a permanent polymeric binder and a sacrificial polymeric binder which has a thermal decomposition temperature at least 20° C. lower than that of the permanent polymeric binder, and
an electrically-conductive second additive,
to obtain a precursor mixture of a composition able to form a second coating of the second electrode, then
c) eliminating at least partially the sacrificial polymeric binder, to obtain said composition.

2. The method for recycling a first electrode according to claim 1, wherein step a) is implemented by a separation process selected from among:
a mechanical separation;
a thermal degradation of the first binder with air jet separation;
a delamination via pulsations;
a chemical delamination;
a froth flotation; and
a combination of at least two of these processes.

3. The method for recycling a first electrode according to claim 1, wherein the method further comprises before step a) a step a0) of providing the first electrode to be recycled, the method having, between steps a0) and b), no step of purification, enrichment, regeneration or pyrolysis of said first coating, the first polymeric binder being kept in the first coating to implement step b).

4. The method for recycling a first electrode according to claim 1, wherein the method further comprises, before step a), a step a0) of providing the first electrode to be recycled which is new so that it is not derived from a battery cell, the method having no step of washing the first coating after step a0) and before mixing thereof at step b) with the second ingredients.

5. The method for recycling a first electrode according to claim 1, wherein the method further comprises, before step a), a step a0) of providing the first electrode to be recycled which is derived from a spent lithium-ion battery cell, the method further comprising, between steps a0) and a) or between steps a) and b), a step a1) of washing the first coating to extract therefrom almost all of an electrolyte that the spent lithium-ion battery contained in contact with the first electrode, by means of an organic washing solvent which is generally inert with respect to the first polymeric binder.

6. The method for recycling a first electrode according to claim 5, wherein the first coating further comprises traces of said electrolyte, which is an aprotic electrolyte based on Li⁺ cations.

7. The method for recycling a first electrode according to claim 1, wherein the mixing of step b) is carried out according to a mass ratio [first coating / (first coating + second active material)] inclusively comprised between 5% and 60%.

8. The method for recycling a first electrode according to claim 1, wherein the mixing of step b) is carried out according to a mass fraction of all of the first coating and of the second active material in the entirety of said precursor mixture which is inclusively comprised between 55% and 85%.

9. The method for recycling a first electrode according to claim 1, wherein the mixing of step b) is carried out with the sacrificial polymeric binder which is selected from among polyalkene carbonates, step c) being implemented by thermal decomposition.

10. The method for recycling a first electrode according to claim 1, wherein the mixing of step b) is carried out with the permanent polymeric binder which is different from the first polymeric binder.

11. The method for recycling a first electrode according to claim 1, wherein each of the first electrode and the second electrode is:
an anode, with the first active material and the second active material which are identical, or
a cathode, with the first active material and the second active material which are identical.

12. The method for recycling a first electrode according to claim 1, wherein the method comprises between steps b) and c) the following steps:
b1) shaping the precursor mixture obtained in b) in the form of a sheet, and
b2) depositing the sheet of the precursor mixture obtained in b1) over a second current collector, in order to obtain the second electrode by implementing step c).

13. A method for recycling at least one cell of a spent lithium-ion battery including an envelope, comprising the following steps:
(i) a dismemberment of said at least one cell to remove said case and recover a first anode comprising a first anode collector covered with a first anode coating impregnated with an electrolyte, a first cathode comprising a first cathode covered with a first cathode coating impregnated with the electrolyte, and a separator, and
(ii) recycling according to claim 5 or 6 of the first anode and/or of the first cathode, each forming said spent first electrode to be recycled.

14. A precursor mixture of an electrode coating composition for a lithium-ion battery, the composition being obtained by a method for recycling a first electrode according to claim 1, wherein the precursor mixture comprises the product of a hot reaction, through a molten process and without solvent, of:
all or part of a first electrode coating which comprises first ingredients comprising a first active material, a first polymeric binder and a first electrically-conductive additive, the first coating being recovered from the first electrode through a separation process selected from among:
a mechanical separation;
a thermal degradation of the first binder with air jet separation;
a delamination via pulsations;
a chemical delamination;
a froth flotation; and
a combination of at least two of these processes, with
new second ingredients usable in a lithium-ion battery second electrode of the same polarity as the first electrode, the second ingredients comprising a second active material compatible with the first active material so that the difference between the respective operating voltages of said first active material and of said second active material is lower than or equal to 1 V in absolute value, a second binder comprising a permanent polymeric binder and a sacrificial polymeric binder which has a thermal decomposition temperature at least 20° C. lower than that of the permanent polymeric binder, and an electrically-conductive second additive.

15. The precursor mixture according to claim 14, wherein the sacrificial polymeric binder is selected from among polyalkene carbonates.

16. The precursor mixture according to claim 14, wherein the first electrode is derived from a spent lithium-ion battery, the first coating which is derived therefrom further comprising traces of an electrolyte that the spent lithium-ion battery contained in contact with the first electrode and which is an aprotic electrolyte based on Li⁺ cations.

17. An electrode composition for a lithium-ion battery, the composition comprising the product of a total or partial thermal decomposition reaction of a precursor mixture according to claim 14.

18. The method for recycling a first electrode according to claim 2, wherein the separation process is selected from among:
a mechanical separation
by abrasion, or
by spraying with subsequent separation of the first current collector;
a thermal degradation of the first binder with air jet separation;
a delamination via pulsations;
a chemical delamination
with ethylene glycol at low temperature, or
by chemical treatment of the first binder with a solvent, to reduce the adhesion of the first binder to the first current collector or to dissolve the first binder in the solvent;
a froth flotation; and
a combination of at least two of these processes.

19. The method for recycling a first electrode according to claim 18, wherein the separation process is selected from among:
a mechanical separation
by abrasion, implemented by scraping or sintering, or
by spraying with subsequent separation of the first current collector, by sieving;
a thermal degradation of the first binder with air jet separation;
a delamination via pulsations which are ultrasounds;
a chemical delamination
with ethylene glycol at low temperature, or
by chemical treatment of the first binder with a solvent, to reduce the adhesion of the first binder to the first current collector or to dissolve the first binder in the solvent;
a froth flotation; and
a combination of at least two of these processes.

20. The method for recycling a first electrode according to claim 7, wherein the mixing of step b) is carried out according to a mass ratio [first coating / (first coating + second active material)] inclusively comprised between 20% and 55%.

21. The method for recycling a first electrode according to claim 9, wherein step c) is implemented in a vat or a furnace,
and in which the sacrificial polymeric binder comprises at least one poly(alkene carbonate) polyol including end groups, more than 50 mol% of which comprise hydroxyl functions, the sacrificial polymeric binder comprising:
a said poly(alkene carbonate) polyol with a weight-average molecular mass comprised between 500 g/mol and 5,000 g/mol, and
a poly(alkene carbonate) with a weight-average molecular mass comprised between 20,000 g/mol and 400,000 g/mol.

22. The method for recycling a first electrode according to claim 10, wherein:
the first polymeric binder comprises a halogenated thermoplastic polymer, and
the permanent polymeric binder comprises a non-halogenated thermoplastic polymer or an elastomer selected from among thermoplastic elastomers and rubbers, including crosslinked or non-crosslinked diene rubbers.

23. The method for recycling a first electrode according to claim 11, wherein each of the first electrode and the second electrode is:
an anode, with the first active material and the second active material which are identical and each comprise the same graphite, or
a cathode, with the first active material and the second active material which are identical and each comprise the same alloy of lithiated oxides of transition metals selected from among the group consisting of alloys of lithiated oxides of nickel, manganese and cobalt (NMC) and alloys of lithiated oxides of nickel, cobalt and aluminium (NCA).

24. A precursor mixture according to claim 14, wherein the first coating is recovered from the first electrode through a separation process selected from among:
a mechanical separation
by abrasion, implemented by scraping or sintering, or
by spraying with subsequent separation of the first current collector, by sieving;
a thermal degradation of the first binder with air jet separation;
a delamination via pulsations which are ultrasounds;
a chemical delamination
with ethylene glycol at low temperature, or
by chemical treatment of the first binder with a solvent, to reduce the adhesion of the first binder to the first current collector or to dissolve the first binder in the solvent;
a froth flotation; and
a combination of at least two of these processes.

25. The precursor mixture according to claim 15, wherein the sacrificial polymeric binder comprises at least one poly(alkene carbonate) polyol including end groups, more than 50 mol% of which comprise hydroxyl functions, and wherein:
the permanent polymeric binder comprises a non-halogenated thermoplastic polymer or an elastomer selected from among thermoplastic elastomers and rubbers, including crosslinked or non-crosslinked diene rubbers, and
the first polymeric binder of the recovered first coating comprises a halogenated thermoplastic polymer.

26. An electrode composition according to claim 17, preferably wherein the composition comprises:
said permanent polymeric binder, which comprises a crosslinked or non-crosslinked diene rubber,
said first polymeric binder of the recovered first coating, which comprises a halogenated thermoplastic polymer, and
optionally in the case where said first electrode is derived from a spent lithium-ion battery, traces of an aprotic electrolyte based on Li+ cations that the spent lithium-ion battery contained in contact with the first electrode, said traces comprising fluorine atoms.
